(19) United States
(12) Patent Application Publication
(10) Pub. No.: US 2014/0012686 A1
(43) Pub. Date: Jan. 9, 2014

(54) SYSTEMS AND METHODS FOR PROVIDING MESSAGE-ENABLED ADVERTISEMENTS AND CONTENT DELIVERY

(71) Applicant: AOL Inc., Dulles, VA (US)

(72) Inventors: Zach Arbon, Tucson, AZ (US); Amanda Mills, Menlo Park, CA (US); Gabriel Giordani, San Francisco, CA (US)

(21) Appl. No.: 13/794,731

(22) Filed: Mar. 11, 2013

Related U.S. Application Data
(60) Provisional application No. 61/668,438, filed on Jul. 5, 2012.

(51) Int. Cl. G06Q 30/02

(52) U.S. Cl. CPC G06Q 30/0277
USPC 705/14.73

(57) ABSTRACT

Systems and methods are disclosed for providing message-enabled advertisements and content delivery, including SMS-enabled advertisements and content delivery. In accordance with one implementation, a method comprises providing, using at least one processor, instructions to display an advertisement together with a user interface on a first device, the user interface including a text entry field. The method also includes receiving a request for sending a message with advertised content to a second device associated with a phone number entered through the text entry field. Further, the method includes providing, using the at least one processor, instructions to send a message to the second device, the instructions including the advertised content and the phone number associated with the second device. In accordance with the present disclosure, at least one of the first device or the second device is a mobile device.

This application claims the benefit of U.S. Provisional Patent Application No. 61/668,438, filed Jul. 5, 2012, which is expressly incorporated herein by reference to its entirety.

### TECHNICAL FIELD

The present disclosure relates generally to systems and methods for providing advertising and content delivery, including mobile advertising and content delivery. More particularly, and without limitation, the present disclosure relates to systems and methods for providing message-enabled advertisements or content delivery that are presented using, for example, a web browser or mobile application.

### BACKGROUND

Advertisements and other content may be displayed in web browsers and used to target, for example, Internet users browsing the World Wide Web. While web browsing is one environment for delivering information and advertisements to users, messaging environments are another due to the increased use of mobile technologies. Moreover, because greater numbers of people are using both computers and mobile devices, there exists a wide range of benefits in linking a user's online browsing experience and/or messaging activities with advertisements or other content.

Prior techniques may display an advertisement in an online web browser to a user, providing a clickable link that opens a new browser window for the user to interact with the advertised content. However, such techniques often require the user to migrate from his or her original Internet web page to a new page, which disrupts the user's browsing experience. Therefore, there is a need for providing improved techniques for presenting mobile advertisements or call-to-actions (e.g., downloads) to users in online or mobile browsing environments.

There also exists a need to allow users to send a short message service (SMS) or other message containing content that is relevant to them or others, without interrupting their browsing experience. Additionally, there exists a need to allow advertisers increased discoverability of certain content or applications by sending information directly to a user's mobile device, rather than requiring a user to download or access it via a device sync using a personal computer before receiving it on their device. There also exists a need to protect users from SPAM and other unwanted content or abuse. Finally, there exists a need to simplify a user's process in determining whether the content advertised is appropriate to their mobile device.

### SUMMARY

Embodiments consistent with the present disclosure provide improved systems and methods for providing advertising and content delivery in web browsers and mobile applications. Moreover, embodiments consistent with the present disclosure include systems and methods for providing message-enabled advertising and content delivery, including SMS-enabled advertising and content delivery.

In accordance with some embodiments, improved techniques are provided for presenting advertisements to a user's client device, with a text or number entry field within or associated with the displayed advertisement, that enable the user to send an SMS or other message without having to leave the web page or opening a separate application.

In accordance with additional embodiments, systems and methods are provided for delivering advertisements or requested content, including an application download, to a user's mobile or computer device and enabling the user to enter, through an entry field associated with the advertisement, a valid mobile number to send an SMS message containing content (e.g., text or a link to content) to a mobile phone associated with the mobile number. Additionally, systems and methods are provided that can identify valid mobile numbers, actively attempt to prevent SPAM, and perform or enable device detection and redirection based on the device's user agent.

Embodiments of the present disclosure also encompass systems and methods that include one or more of the following features: (i) a number lookup service to determine whether a destination number, entered into the entry field for an advertisement, is a valid mobile number; (ii) device detection and redirection for links that are included in a message to ensure that users are served content appropriate to their mobile device (e.g., Apple App Store versus Google Play App Store); and (iii) one or measures to prevent SPAM and abuse, including IP whitelisting, domain whitelisting, and/or frequency algorithms.

In accordance with an embodiment of the present disclosure, an entry field or user interface may be configurable using JavaScript and/or CSS. Further, the look and feel of an entry field or user interface may be designed to be consistent with the brand or advertiser that it represents. Additionally, customization of an entry field or user interface may be supported to allow advertisements to be quickly created and deployed by a knowledgeable developer or designer.

In accordance with still further embodiments of the present disclosure, a test interface may be provided that allows a developer to quickly, and easily, determine whether their implementation is working and troubleshoot any issues.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosed embodiments.

FIG. 1 depicts a block diagram of an exemplary system environment in which embodiments consistent with the present disclosure may be practiced and implemented;

FIG. 2 depicts a flowchart of an exemplary method for providing message-enabled advertisements and content delivery, consistent with embodiments of the present disclosure;

FIG. 3 depicts a flowchart of an exemplary method for validating phone numbers for providing message-enabled advertisements and content delivery, consistent with embodiments of the present disclosure;

FIG. 4 depicts a flowchart of an exemplary method for validating mobile devices for providing message-enabled advertisements and content delivery, consistent with embodiments of the present disclosure;

FIG. 5 depicts a flowchart of an exemplary method for providing anti-SPAM techniques, consistent with embodiments of the present disclosure;

FIG. 6 depicts a flowchart of an exemplary method for verifying the protection of an SMS message, consistent with embodiments of the present disclosure;

FIG. 7 depicts an exemplary advertisement that may be generated with systems and methods consistent with embodiments of the present disclosure;

FIG. 8 depicts another exemplary advertisement that may be generated with systems and methods consistent with embodiments of the present disclosure;

FIG. 9 depicts another exemplary advertisement that may be generated with systems and methods consistent with embodiments of the present disclosure;

FIG. 10 depicts a flowchart of an exemplary method for loading an SMS-enabled advertisement on a website, consistent with embodiments of the present disclosure; and

FIG. 11 depicts a flowchart of an exemplary method for sending an SMS message via an SMS-enabled advertisement on a website, consistent with embodiments of the present disclosure.

### DETAILED DESCRIPTION OF THE EMBODIMENTS

Reference will now be made in detail to exemplary embodiments, examples of which are illustrated in the accompanying drawings. Wherever possible, the same reference numbers will be used throughout the drawings to refer to the same or like parts.

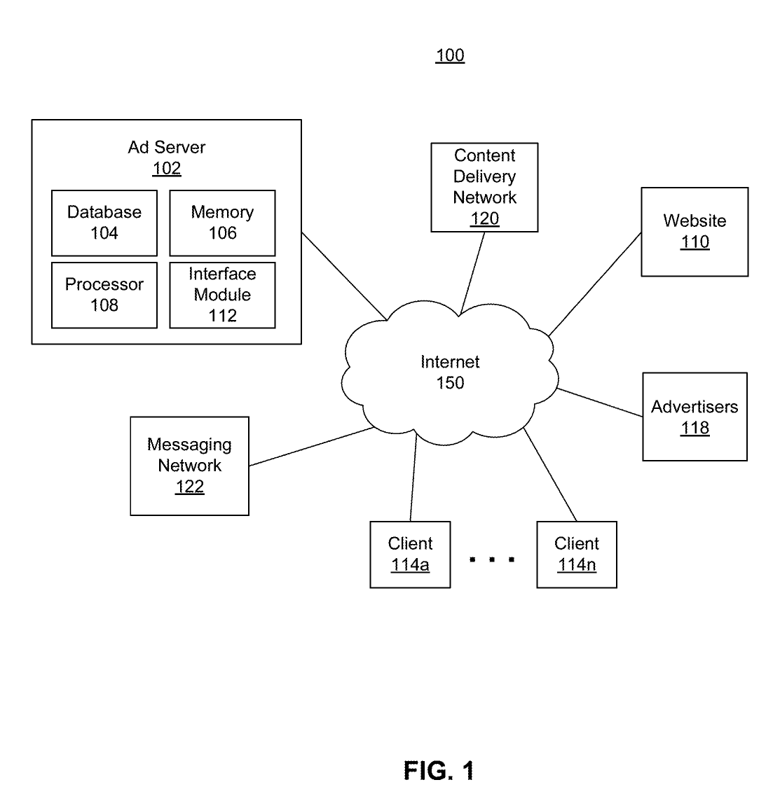

FIG. 1 illustrates an exemplary system environment 100 in which embodiments consistent with the present disclosure may be practiced and implemented. As disclosed herein, environment 100 of FIG. 1 may be used for providing message-enabled advertising and content delivery in web browsers and mobile applications. As will be appreciated from the present disclosure, while FIG. 1 and the other figures described herein reference SMS-based messaging and related techniques, embodiments of the present disclosure may be implemented for other messaging features and related techniques, including proprietary or open messaging protocols (e.g., Apple Messages, KakaoTalk, LiveProfile, PingChat!, Google Voice, Line2, Kik). Further, while in various sections reference is made to delivery of advertisements, the techniques and embodiments disclosed herein may be applied to the delivery of other electronic content.

As shown in FIG. 1, system environment 100 may include an advertisement server (“ad server”) 102, a Content Delivery Network (“CDN”) 120, a website 110, a messaging network 122, a plurality of client devices (“clients”) 114a-114n, and an advertiser 118. All of these components may be disposed for communication with one another via an electronic network, such as Internet 150 and/or other communication networks (not shown). Further, as will be appreciated from this disclosure, the number and orientation of these components may be modified, and system environment 100 may include one or more of the above-listed components.

Ad server 102 may be configured to generate and manage advertisements for display on one or more websites 110. Advertisements may also be displayed through or in association with a mobile application (i.e., a mobile app). Ad tags on a website (e.g., HTML code) or associated with a mobile application may cause a client 114 (i.e., one of client 114a-114n, which may comprise desktop computers, laptops, or mobile devices—including mobile phones and PDAs) to request an advertisement from ad server 102 and/or CDN 120 (e.g, directly or through a redirect). The requested ad may then be displayed on client 114. Advertiser 118 may schedule advertising campaigns through ad server 102, designating the advertisements and where they should be displayed, among other parameters.

As further shown in FIG. 1, ad server 102 may include a database 104, a memory 106, a processor 108. In addition, ad server 102 may include an interface module 112. Interface module 112 may interact with website 110 to assist with data validation and coordinating messages based on a phone number entered by a user of client 114 through an entry field or user interface associated with an advertisement. As further disclosed herein, a text or number entry field may be provided within or associated with a displayed advertisement. Such a field may enable the user to send an SMS or other message via messaging network 122, without having to leave the web page or open a separate application.

In accordance with an embodiment, interface module 112 can identify valid mobile numbers, actively attempt to prevent SPAM (e.g., through STOP text messaging functionality), and/or manage device detection and redirection based on the device's user agent. In some embodiments, website 110 may assist the operations of interface module 112 by, for example, verifying that the data entered by a user is numeric data in a proper format, and forwarding properly entered phone numbers to interface module 112 for validation and subsequent messaging. Verification logic may be used to clear potentially invalid numbers or numbers that have expressly blocked the delivery of text messages to that device via their network operator.

Consistent with embodiments of the present disclosure, ad server 102 may be configured to generate and manage advertisements that include an entry field for a user of client 114 to textually enter a phone number associated with a mobile device (i.e., one of client devices 114a-114n). The user may enter his or her own phone number or another phone number, such as a friend's phone number. Interface module 112 may be configured to receive the entered phone number and verify that it is a valid number in a mobile network. Interface module 112 may also verify that messaging is supported by the mobile network (not shown) associated with client 114. Furthermore, interface module 112 may be configured to send an SMS or other message to a mobile device (i.e., one of client devices 114a-114n) providing content associated with the advertisement displayed in interface module 112. For purposes of sending an SMS or other message, interface module 112 may coordinate and/or instruct the sending of the message via messaging network 122, which may comprise an SMS or other suitable messaging network.

In some embodiments, the entry field or user interface may be displayed via a web browser of client 114, such as conventional web browsers used to access a web site with a desktop computer, laptop, or a mobile device—including mobile phones and PDAs. The entry field or user interface may also be displayed in connection with an advertisement via a mobile application on a mobile device. Example mobile applications include apps for providing news, weather, games, and navigation.

With respect to FIG. 1 and the other exemplary embodiments disclosed herein, the term “user” may refer to any consumer, viewer, or visitor of a web page or site or a mobile application. References to users “viewing” ads are meant to include any presentation or content, whether electronic, digital, or virtual.

Website 110 may include any entity that provides online web browsing services and that desire to provide advertisements to users. For example, one or more websites 110 may be provided, including AOL, Bing, CNN, Facebook, Google, and Yahoo! Additionally, website 110 may include any business entity that provides mobile applications to users and/or that desires to provide advertisements to such users. For example, website 110 may include Skype, Twitter, Yelp, or Zynga. Each website 110 may interact with ad server 102 (including the components thereof) either directly or through the Internet 150.

Advertiser 118 may comprise any entity that desires to advertise to users on the Internet 150 or via mobile applications. For example, advertiser 118 may include a business entity that sells products or services and desires to advertise their products or services online or via mobile applications. Advertiser 118 may interact with ad server 102 in system environment 100 either directly or through the Internet 150. In other embodiments, advertiser 118 may interact with ad server 102 through web site 110.

As shown in FIG. 1, ad server 102 may include a processor 108, memory device 106 (“memory”), and database 104. Database 104 may store advertisement content alone or in combination with CDN 120. Database 104 may also store message content for delivery to clients 114a-114n via messaging network 122. Databases 104 may also be used to store phone numbers and/or other information to assist interface module 112 with verifying that a phone number entered by a user is currently supported by a mobile network or that a particular mobile network supports SMS or other messaging protocols.

Memory 106 may store a set of programmable instructions that are executable by processor 108 to enable the operations of ad server 102, as disclosed herein. Memory 106 may also store a set of programmable instructions that are executable by interface module 112 (which may include at least one processor or utilize processor 108), to enable the operations of interface module 112, as disclosed herein. Additionally, memory 106 may be used for recording or otherwise storing information, such as phone numbers, advertisement content, message content, etc.

Processor 108 may be configured to execute the set of programmable instructions in memory 106 and use the information stored in database 104 and memory 106, where needed, to generate and provide advertisements, in accordance with the embodiments disclosed herein. Processor 108 may also be configured to receive information from a user and, alone or with interface module 112, send SMS or other messages to a mobile device. Processor 108 may also be configured to protect a user and/or mobile device from SPAM and other unwanted content or abuse of its advertising services from the use of ad server 102 or interface module 112.

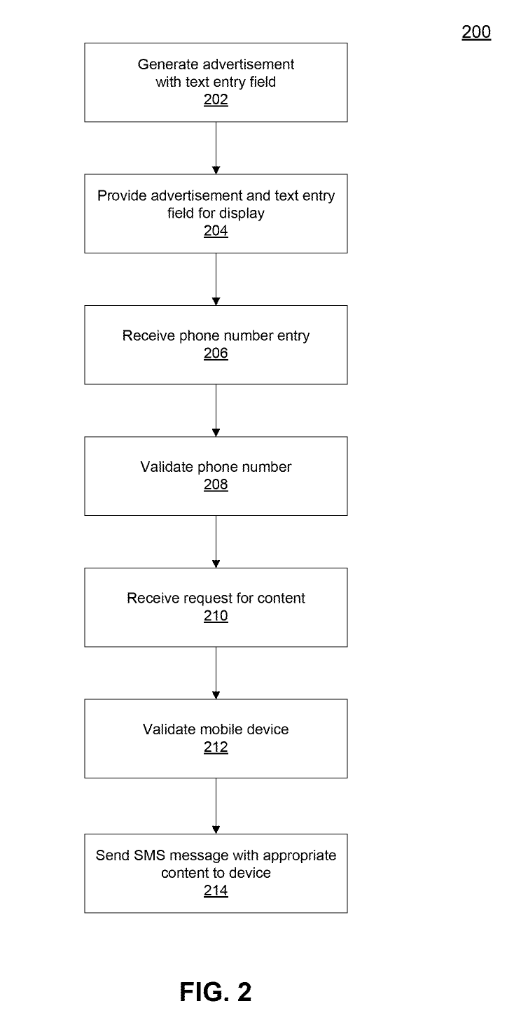

FIG. 2 depicts a flowchart of an exemplary method 200 for providing message-enabled advertisements or content delivery using, for example, ad server 102 of FIG. 1. While FIG. 2 is described with reference to SMS-based messaging and related techniques, the exemplary method may be implemented using other messaging features and related techniques, including proprietary or open messaging protocols, as noted above.

As shown in FIG. 2, method 200 may include generating an advertisement with a text entry field (step 202). Ad server 102 may generate ads with a text entry field (or other user interface) based on information from advertiser 118. In addition, ad server 102, alone or in combination with CDN 120, may provide content and instructions for displaying an advertisement with a text entry field in a web browser or mobile application of client 114 (step 204). Ad server 102 (or, more specifically, interface module 112) may receive an entered phone number from website 110 or a mobile application of client 114 (step 206). For example, user of client 114 may view a web browser or mobile application that displays an advertisement and text entry field, and enter a phone number for sending a message to a mobile device associated with the entered phone number.

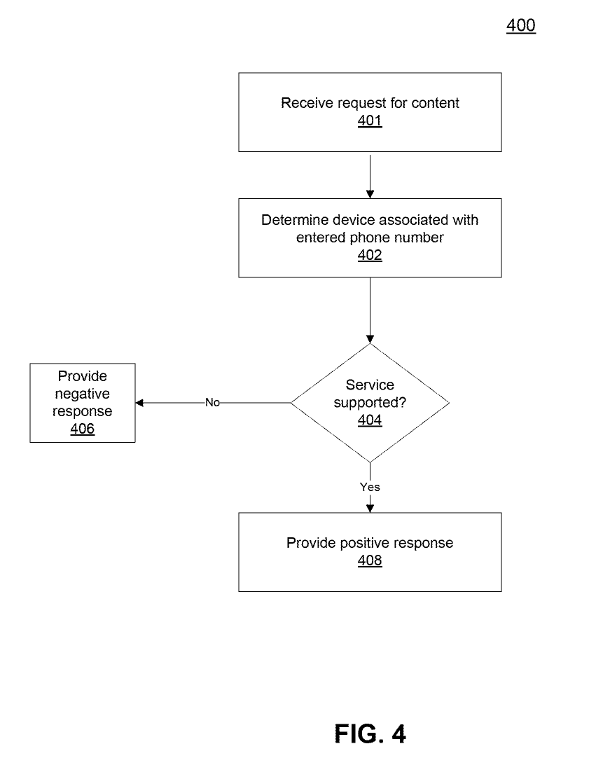

Ad server 102 (or, more specifically, interface module 112) may validate the entered phone number (step 208). For example, processor 108 or interface module 112 may use verification logic to determine whether the entered phone number is valid. In one embodiment, the entered phone number may be compared to phone numbers stored in database 104 or memory 106. Ad server 102 may provide a response (positive or negative) that is displayed to a user to indicate whether the entered phone number was verified or, if not, not verified. An exemplary embodiment in this regard is described below with reference to FIG. 4.

Returning to FIG. 2, upon verifying that the entered phone number is valid, ad server 102 may receive a request for the advertised content (step 210). For example, the user of client 114 may select a displayed “Send” button or may otherwise request that ad server 102 send the advertised content to a mobile device associated with the validated phone number. In response, ad server 102 (or, more specifically, interface module 112) may validate that the mobile device associated with the phone number can receive the advertised content (step 212). For example, ad server 102 or interface module 112 may determine whether its services are supported by the mobile network operator (not shown) of the mobile device. In one embodiment step 212 is performed prior to step 210, such as with or after step 208.

Ad server 102 may generate and send an SMS message containing the requested content to the mobile device associated with the entered phone number (step 214). The SMS message may be coordinated through messaging network 122 and/or Internet 150. In one embodiment, the requested content may comprise a hyperlink and/or textual information. For example, the SMS message may include the following: “Get AOL.com for mobile at: http://mobile.aol.com.” In other embodiments, the requested content may be a mobile application to be downloaded to the mobile device. In such cases, an SMS message may be sent to the mobile device containing a hyperlink to download the mobile application. Textual information may also be provided in the SMS message to describe, for example, the mobile application or how to download the same. For example, the SMS message may include the following: “Get the Moviefone app at: https://aol.it/moviefone.”

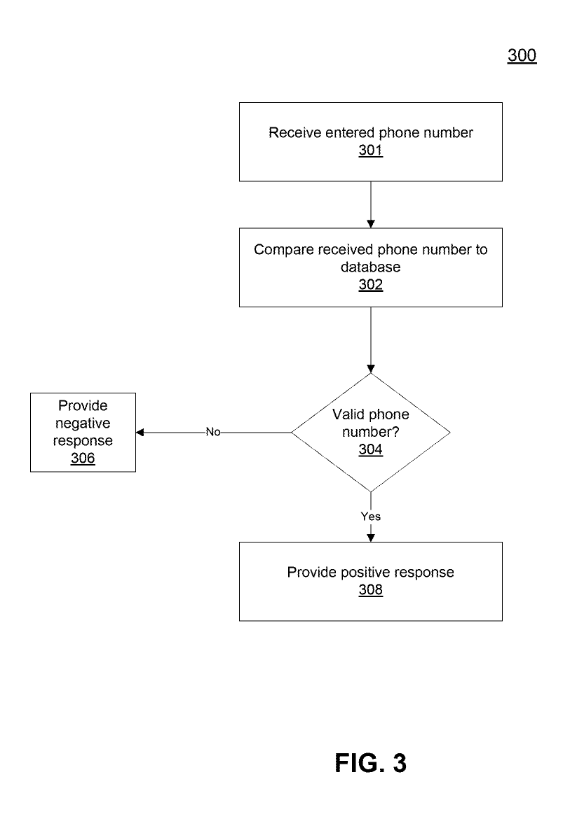

FIG. 3 depicts a flowchart of an exemplary method 300 for validating entered phone numbers in a message-enabled (such as an SMS-enabled) advertisement or content delivery system using, for example, ad server 102 of FIG. 1. In method 300, ad server 102 (or, more specifically, interface module 112) may receive an entered phone number (step 301). The entered phone number may be compared to a list of valid phone numbers stored in database 104 or memory 106 or similarly analyzed (step 302). For example, in one embodiment, based on the comparison or other analysis of the entered phone number, ad server 102 or interface module 112 may determine, using verification logic, whether the entered phone number is a valid phone number (step 304). If not, ad server 102 or interface module 112 may generate a negative response to be displayed to the user of client 114 (step 306). For example, if the user enters an invalid phone number such as “999-999-9999” into the text entry field, ad server 102 or interface module 112 may determine that the entered number is not a valid phone number in a mobile network provided by a mobile network operator. The negative response displayed to the user may indicate that the number is invalid (e.g., “Invalid Number”). Additionally, or alternatively, the user may be prompted to enter another phone number for validation.

If the entered number is valid, ad server 102 or interface module 112 may provide a positive response to be displayed to the user of client 114 in the displayed advertisement (step 308). For example, ad server 102 may provide a response indicating that the number is valid (e.g., “Valid Number”). The user may then be prompted to confirm the sending of a message to the validated phone number (“Press Send”).

FIG. 4 depicts a flowchart of an exemplary method 400 for validating mobile devices associated with entered phone numbers in a message-enabled (such as an SMS-enabled) advertisement or content delivery system using, for example, ad server 102 of FIG. 1. In method 400, ad server 102 may receive a request for the advertised content (step 401). For example, user 114 may select a “Send” button displayed on website 110 or a mobile application, to request content via an SMS message. The request may contain the entered phone number that was verified to be valid.

After receiving the request (step 401), ad server 102 may determine the type of device associated with the entered phone number (step 402). For example, ad server 102 may determine that an Android™ smart phone is associated with the entered phone number's mobile browser. Additionally, or alternatively, ad server 102 may determine that another type of mobile phone, or even a landline phone, is associated with the entered phone number's mobile browser.

Ad server 102 may determine whether the identified device supports receiving the requested content (step 404). In one embodiment, ad server 102 may determine whether the advertising content provided by ad server 102 is supported by the device's mobile network operator, if applicable. For example, ad server 102 may determine whether the Android™ smart phone's mobile network operator (e.g., Verizon) supports receiving SMS messages containing hyperlinks to an online web page or to a mobile application store. In another embodiment, ad server 102 may determine whether a mobile device's service with a mobile network operator supports receiving the advertised content. For example, the mobile device's mobile service may not support receiving SMS messages. In other embodiments, the mobile device may not support accessing and downloading mobile applications from a mobile application store, such as iTunes®.

If ad server 102 determines that its advertising services are not supported, it may provide a negative response for display to the user of client 114 (step 406). For example, in one embodiment, if the mobile device does not support accessing a mobile application store, ad server 102 may provide a negative response to the user, such as a response indicating that mobile device is not supported. In other embodiments, if the entered phone number corresponds to a landline phone and not a mobile device, ad server 102 may provide a negative response, such as a response indicating that the number is associated with a landline device (e.g., “This is not a mobile number”).

If the mobile device is supported, ad server 102 may provide a positive response to be displayed to the user of client 114 (step 408). For example, ad server 102 may provide a response indicating that the request for the advertised content has been successfully received (e.g., “Request Successful”).

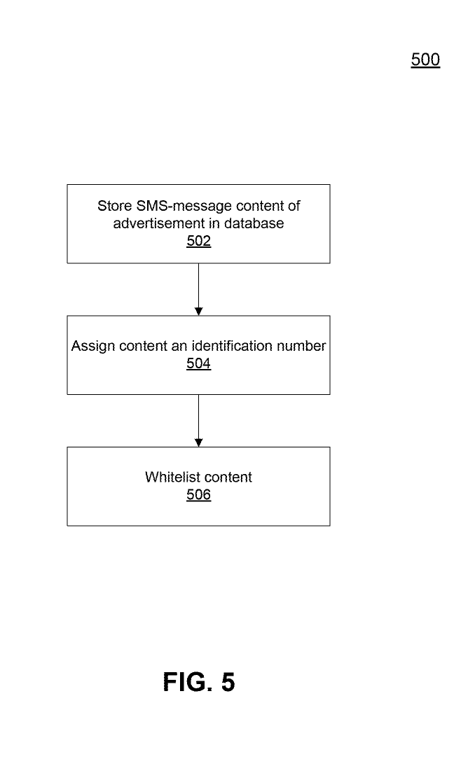

FIG. 5 depicts a flowchart of an exemplary method 500 for providing anti-SPAM techniques using, for example, ad server 102 of FIG. 1. By way of example, method 500 may include storing the content of an SMS message associated with the displayed advertisement in a database, such as database 104 (step 502). Method 500 may also include assigning the content a unique identification (ID) number (step 504). In one embodiment, ad server 102 may use the unique ID number to identify the content of the appropriate SMS message to be sent to the mobile device when it receives a request from the user. Method 500 may also include whitelisting the content, according to known techniques for whitelisting online data (step 506). For example, in one embodiment, ad server 102 may whitelist the entities associated with originating the request, such as the user and/or website 110. In other embodiments, ad server 102 may whitelist any hyperlinks or associated IP addresses that may be provided in an SMS message to the mobile device. In even further embodiments, ad server 102 may whitelist the actual content (e.g., textual content) of the SMS message to be sent to the mobile device.

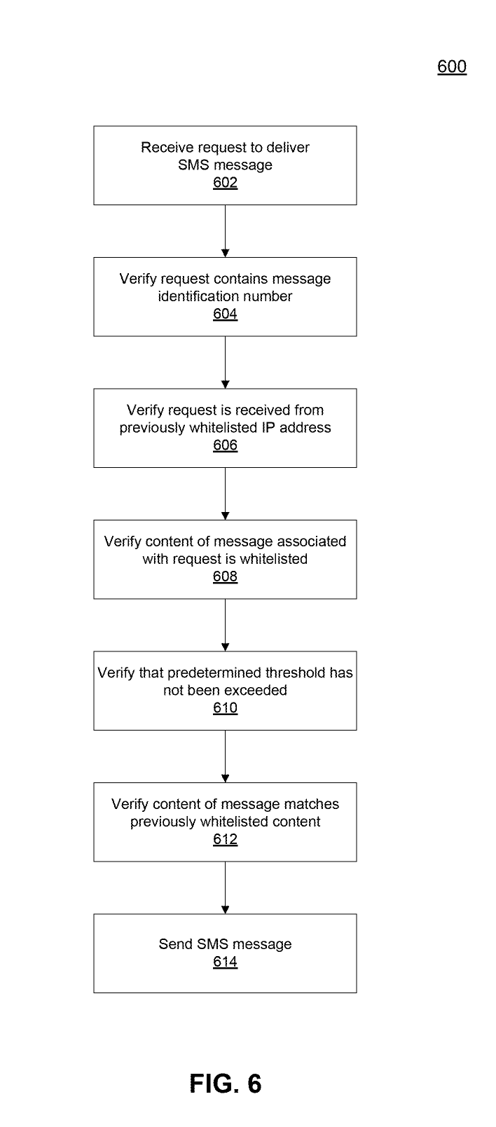

FIG. 6 depicts a flowchart of an exemplary method 600 for verifying the protection of an SMS message against SPAM or other unwanted content or abuse using, for example, ad server 102 of FIG. 1. Method 600 may include receiving a request to deliver an SMS message to a mobile device (step 602). For example, ad server 102 may receive the request once the user of client 114 selects a “Send” button or otherwise requests the advertised content. Ad server 102 may verify that the request contains the unique ID number associated with the content of the requested SMS message (step 604). Ad server 102 may verify that the request is received from a previously whitelisted IP address (FIG. 5) (step 606). Ad server 102 may verify that the content of the SMS message and/or any links within the content, associated with the request and/or the unique ID number, is whitelisted (step 608). Ad server 102 may verify that the mobile device associated with the entered phone number has not received more than a predetermined number of messages within a predetermined time period (step 610). In one embodiment, ad server 102 may limit the number of messages sent to a particular phone number to prevent abuse and/or distribution of SPAM by entities using ad server 102. In other embodiments, ad server 102 may also limit the number of messages based on a predetermined period of time. For example, ad server 102 may limit the delivery of messages to one message every thirty minutes. Ad server 102 may verify that the content of the SMS message to be delivered to the mobile device in response to the received request matches the previously whitelisted content for SMS messages associated with the displayed advertisement (step 612). Ad server 102 may then send the SMS message to the mobile device (step 614).

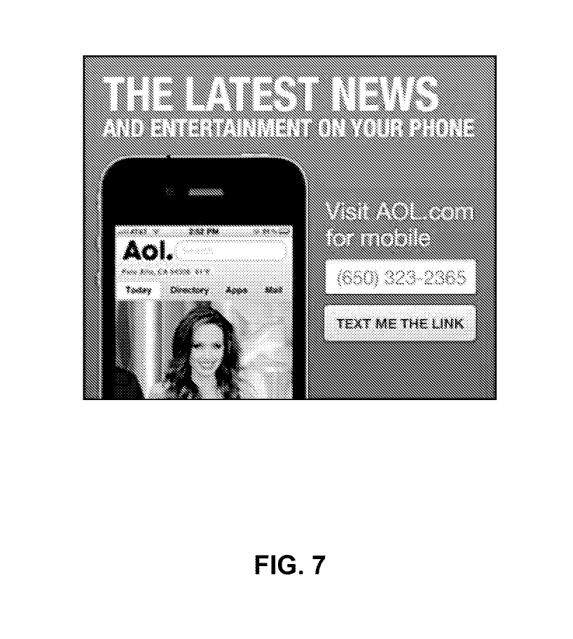

FIG. 7 depicts an exemplary advertisement that may be generated with systems and methods consistent with embodiments of the present disclosure. The exemplary advertisement of FIG. 7 may include an area for a text entry field or other user interface that allows a user to enter a phone number for sending a SMS message (e.g. “650-323-2365”). The exemplary advertisement may also include information describing the advertised content (e.g., “The Latest News and Entertainment on Your Phone”). The exemplary advertisement may also include a digital or electronic button, clickable by a user, for submitting a request to have the advertised content sent to a mobile device associated with the entered phone number (e.g., “Text Me the Link”). The exemplary advertisement may be displayed on client 114's web browser or on a mobile application.

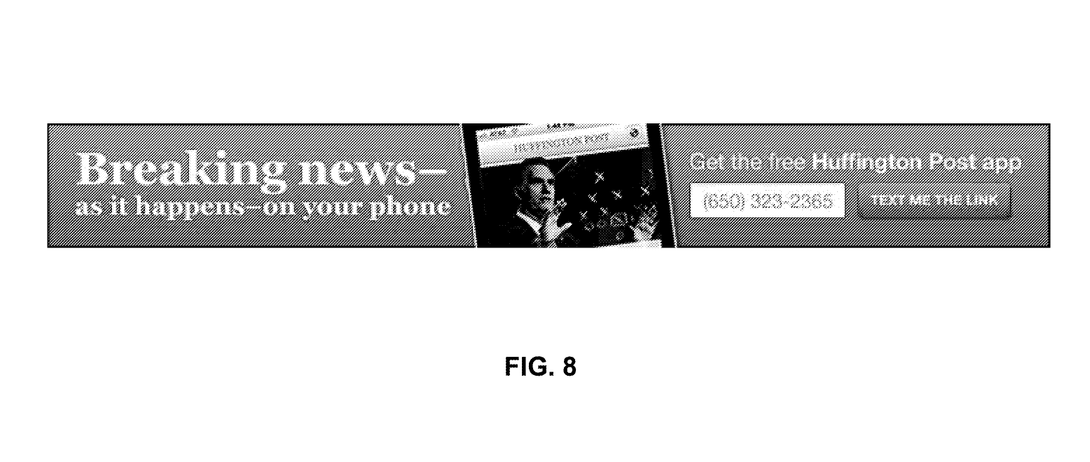

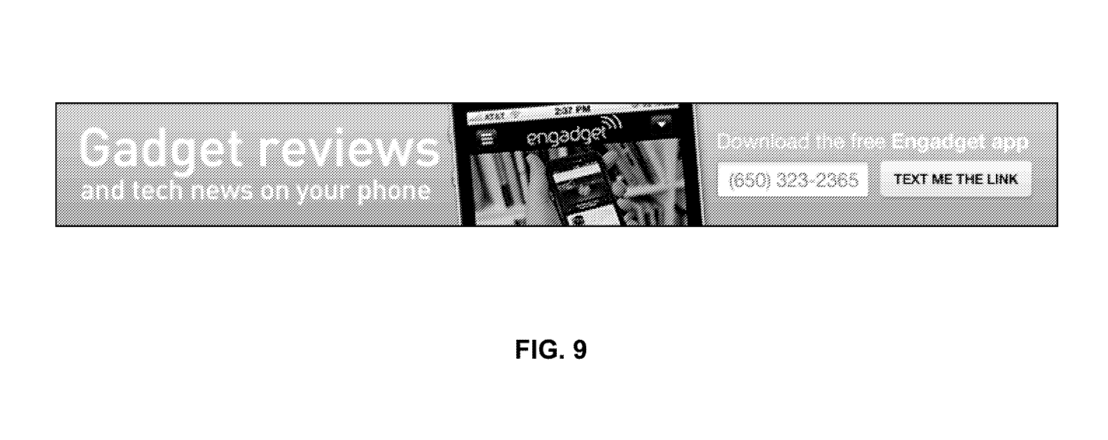

Consistent with embodiments of the present disclosure, other forms of advertisements may be displayed for delivering SMS-enabled advertisements to a user. For example, FIGS. 8 and 9 depict different forms of exemplary SMS-enabled advertisements that may be generated with systems and methods consistent with embodiments of the present disclosure.

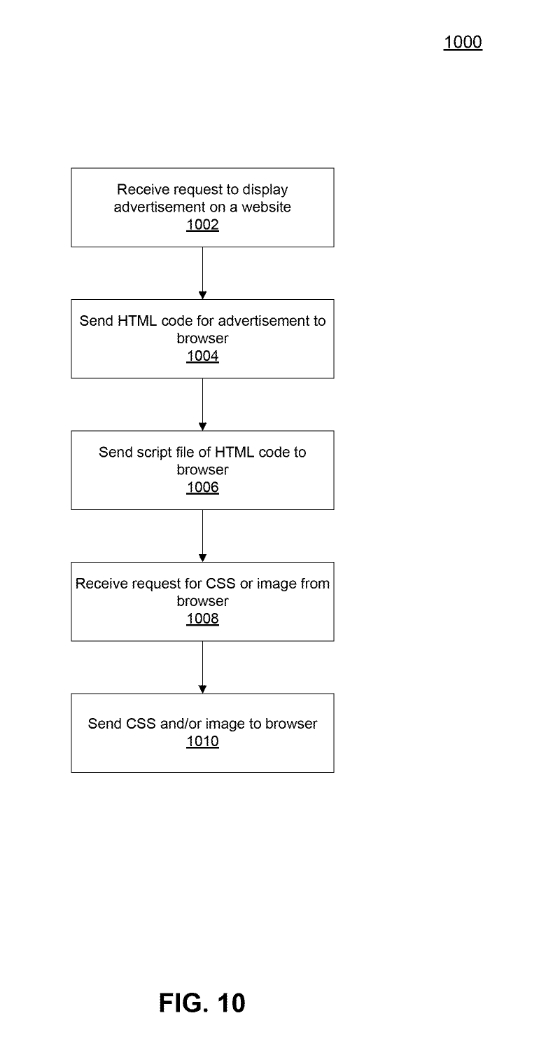

FIG. 10 depicts a flowchart of an exemplary method 1000 for loading an SMS-enabled advertisement on website 110 using, for example, ad server 102 of FIG. 1. In step 1002, ad server 102 may receive a request from website 110 (via a browser) for an advertisement. In step 1004, ad server 102 may send HTML code containing the code for displaying the advertisement to the browser, which may process the code for display. The HTML code may be tailored to override Cascading Style Sheet (CSS) behavior and script parameters, such that the advertisement is in a state ready for user interaction. In step 1006, CDN 120 may load the script file referenced in the HTML code. For example, the browser may request JavaScript for the advertisement from CDN 120, and CDN 120 may return the requested JavaScript to the browser for execution. In step 1008, CDN 120 may receive a request from the browser for the advertisement's CSS and/or image, and CDN 120 may return the requested information to browser in step 1010. The ad code from the HTML code may override styles and specify the advertisement's dimensions and image location. As a result, the advertisement may be displayed to a user in website 110 rendered on a browser of client 114.

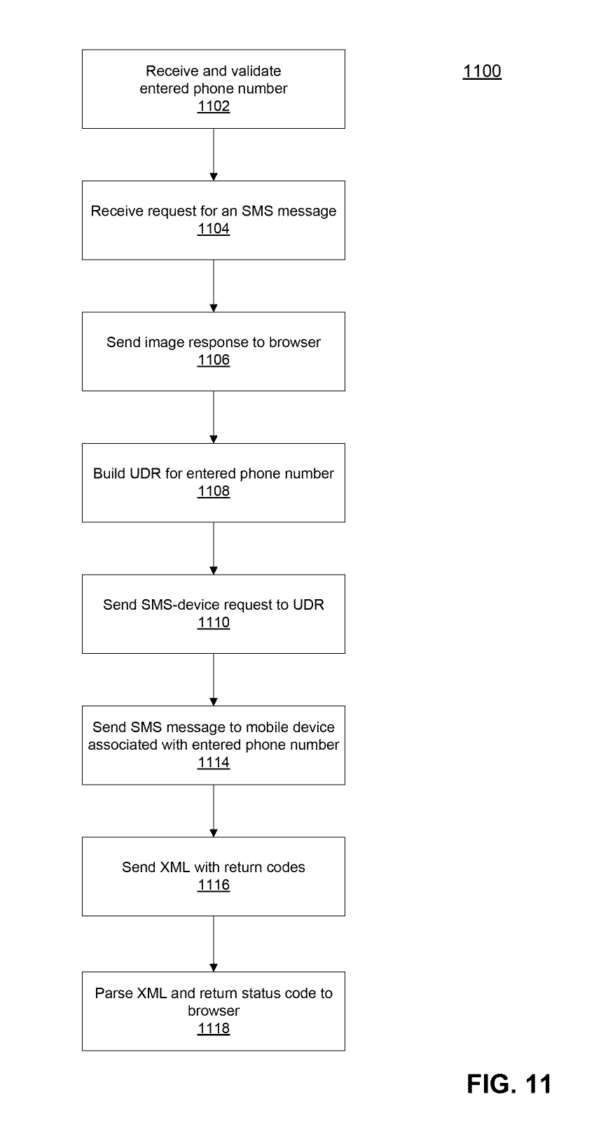

FIG. 11 depicts a flowchart of an exemplary method 1100 for sending an SMS-enabled advertisement to website 110 using, for example, ad server 102 and interface module 112 of FIG. 1. In step 1102, interface module 112 (via a browser) may receive an entered phone number by the user and may validate the entry. For example, interface module 112 may check the value entered to determine whether ten digits are present. Interface module 112 may compare the value entered against a phone number pattern and, if invalid, may delete the contents in the entry field. In step 1104, a request may be received by a server (e.g., ad server 102 or another server) for a message to be sent to a device from the browser, containing the value entered and other data parameters. For example, a user may select a clickable “Send” button in the browser, which may send the request to ad server 102. In step 1106, ad server 102 may send an image response back to the browser. Ad server 102 may build a user data request (UDR) in step 1110 by looking up pertinent information for sending the message, such as the identification of the requested application (if any) (e.g., Moviefone application), the message values for the requested message (e.g., “Get Moviefone: https://aol.it/moviefone”), etc. In step 1112, ad server 102 may send to UDR an SMS device request with the entered phone number and other information for generating the SMS message, including the body of the message, the identification of the application, an IP address of client 114, etc. UDR may send a message in step 1114, via SMS or the Internet, to the mobile device associated with the entered phone number. In step 1116, UDR may respond with XML to ad server 102 with a number of possible return codes. Ad server 102 may parse the XML response and return a status code and/or JavaScript Objection Notation (JSON) elements to the browser in step 1118 for execution by the browser.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, systems and methods consistent with the disclosed embodiments may be implemented as a combination of hardware and software or in hardware alone. Examples of hardware include computing or processing systems, including personal computers, laptops, mainframes, micro-processors and the like. Additionally, although aspects are described for being stored in memory, one skilled in the art will appreciate that these aspects can also be stored on other types of computer-readable media, such as secondary storage devices, for example, hard disks, floppy disks, or CD-ROM, or other forms of RAM or ROM.

Programmable instructions, including computer programs, based on the written description and disclosed embodiments are within the skill of an experienced developer. The various programs or program modules can be created using any of the techniques known to one skilled in the art or can be designed in connection with existing software. For example, program sections or program modules can be designed in or by means of C#, Java, C++, HTML, XML, or HTML with included Java applets. One or more of such software sections or modules can be integrated into a computer system or existing e-mail or browser software.

Moreover, while illustrative embodiments have been described herein, the scope of thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

The sample claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

It is intended, therefore, that the specification and examples be considered as exemplary only. Additional embodiments are within the purview of the present disclosure.

What is claimed is:

1. A computer-implemented method for providing message-enabled content delivery, the method comprising:
providing, using at least one processor, instructions to display an advertisement together with a user interface on a first device, the user interface including a text entry field;
receiving a request for sending a message with advertised content to a second device associated with a phone number entered through the text entry field; and
providing, using the at least one processor, instructions to send a message to the second device, the instructions including the advertised content and the phone number associated with the second device.

2. The method of claim 1, further comprising:
verifying that the entered phone number is valid.

3. The method of claim 2, further comprising:
providing instructions to display a response on the first device indicating that the entered phone number is valid.

4. The method of claim 1, further comprising:
verifying that the second device can receive the message.

5. The method of claim 4, further comprising:
providing instructions to display a response on the first device indicating that the request was successfully received.

6. The method of claim 1, wherein the first device includes a web browser and the advertisement and the user interface are displayed with the web browser.

7. The method of claim 1, wherein the first device includes a mobile application.

8. The method of claim 1, wherein the advertised content includes at least one of a hyperlink or text.

9. The method of claim 1, wherein the message is an SMS message.

10. The method of claim 1, wherein at least one of the first device and the second device is a mobile device.

11. A system for providing message-enabled content delivery, the system comprising:
a processor;
a memory storing instructions which, when executed by the processor, cause the system to:
provide instructions to display an advertisement together with a user interface on a first device, the user interface including a text entry field;
receive a request for sending a message with advertised content to a second device associated with a phone number entered through the text entry field; and
provide instructions to send a message to the second device, the instructions including the advertised content and the phone number associated with the second device.

12. The system of claim 11, further comprising instructions which, when executed by the processor, cause the system to:
verify that the entered phone number is valid.

13. The system of claim 12, further comprising instructions which, when executed by the processor, cause the system to:
provide instructions to display a response on the first device indicating that the entered phone number is valid.

14. The system of claim 11, further comprising instructions which, when executed by the processor, cause the system to:
verify that the second device can receive the message.

15. The system of claim 14, further comprising instructions which, when executed by the processor, cause the system to:
provide instructions to display a response on the first device indicating that the request was successfully received.

16. The system of claim 11, wherein the first device includes a web browser and the advertisement and the user interface are displayed with the web browser.

17. The system of claim 11, wherein the first device includes a mobile application.

18. The system of claim 11, wherein the advertised content includes at least one of a hyperlink or text.

19. The system of claim 11, wherein the message is an SMS message.

20. The system of claim 11, wherein at least one of the first device and the second device is a mobile device.
